(19) United States
(12) Patent Application Publication
(10) Pub. No.: US 2018/0281559 A1
(43) Pub. Date: Oct. 4, 2018

(54) ACOUSTIC AIR DUCT AND AIR EXTRACTION SYSTEM WITH NESTING EXPANSION CHAMBERS

(71) Applicant: FORD GLOBAL TECHNOLOGIES, LLC, Dearborn, MI (US)

(72) Inventors: Patrick James Blanchard, Ann Arbor, MI (US); Haibo Zhao, Northville, MI (US)

(21) Appl. No.: 15/473,172

(22) Filed: Mar. 29, 2017

(51) Int. Cl. B60H 1/00; B60H 1/24

(52) U.S. Cl. CPC B60H 1/00564; B60H 2001/006; B60H 1/248

(57) ABSTRACT

An air extraction system includes an air inlet, an air extractor in an acoustic air duct extending from the air inlet to the air extractor. The acoustic air duct includes an outer wall defining an elongated airflow passageway and a plurality of channels extending along and dividing the airflow passageway within the outer wall. A first channel of the plurality of channels includes alternating expansion chambers and constriction zones.

### TECHNICAL FIELD

This document relates generally to the motor vehicle equipment field and, more particularly, to an acoustic air duct and an air extraction system having nesting expansion chambers as well as to a related method of reducing noise transmitted through an air duct.

### BACKGROUND

A motor vehicle air extraction system provides a number of functions, allowing proper airflow inside a passenger cabin of a motor vehicle, controlling window fogging and even reducing door closing effort. Such an air extraction system incorporates an inlet such as a trim panel inlet, an air extractor and an air duct connecting the trim panel inlet to the air extractor.

In order to accommodate a desired airflow inside the passenger cabin, that air duct is ideally designed to have a large diameter and no expansion chamber. In order to control noise, vibration and harshness (NVH), that air duct is ideally designed to have a small diameter and an expansion chamber. This document relates to a new and improved acoustic air duct and a new and improved air extraction system uniquely designed and adapted to meet these seemingly conflicting requirements. A related method of reducing noise transmitted through an air duct is also provided.

### SUMMARY

In accordance with the purposes and benefits described herein, a new and improved acoustic air duct is provided. That acoustic air duct comprises an outer wall defining an elongated internal airflow passageway and a plurality of channels extending along the airflow passageway within the outer wall. A first channel of the plurality of channels includes alternating expansion chambers and constriction zones.

Each expansion chamber may have a first cross sectional area of between 320 mm² and 3,200 mm² and a first total volume of between 8,182 mm³ and 487,680 mm³. Each constriction zone may have a second cross sectional area of between 80 mm² and 800 mm² and a second total volume of between 2,032 mm³ and 121,920 mm³. Further, the plurality of channels may be circular in cross section.

In some of the many possible embodiments of the acoustic air duct, the plurality of channels may be made from an acoustic material. For purposes of this document, an acoustic material means a material designed to absorb sound.

A second channel of the plurality of channels may also include alternating expansion chambers and constriction zones. In some of the many possible embodiments, the expansion chambers of the first channel nest in the constriction zones of the second channel and the expansion chambers of the second channel nest in the constriction zones of the first channel.

In accordance with an additional aspect, an air extraction system is provided for a motor vehicle. That air extraction system comprises an inlet, such as a trim panel inlet, an air extractor and an acoustic air duct extending from the trim panel inlet to the air extractor. The acoustic air duct includes an outer wall defining an elongated airflow passageway and a plurality of channels extending along the airflow passageway within the outer wall. A first channel of the plurality of channels includes alternating expansion chambers and constrictions zones extending in series along the length of the first channel.

A second channel of the plurality of channels may also include alternating expansion chambers and constriction zones extending in series along the length of the second channel. In some of the many possible embodiments, the expansion chambers of the first channel nest in the constriction zones of the second channel and the expansion chambers of the second channel nest in the constriction zones of the first channel.

In some of the many possible embodiments of the air extraction system, at least one channel of the plurality of channels has a circular cross section. The plurality of channels may be made from an acoustic material.

In accordance with still another aspect, a method is provided for reducing noise transmission through an air duct. That method comprises dividing an internal airflow passageway in the air duct with a plurality of channels wherein a first channel of the plurality of channels includes alternating expansion chambers and constriction zones.

The method may further include the step of internesting the first channel with a second channel of the plurality of channels also having alternating expansion chambers and constriction zones. In such a configuration, the expansion chambers of the first channel nest in the constriction zones of the second channel and the expansion chambers of the second channel nest in the constriction zones of the first channel.

The method may also include the step of making the plurality of channels from an acoustic material. Still further, the method may include the step of extending the air duct from an air inlet, such as a trim panel inlet, to an air extractor. In addition, the method may include the step of providing the internal airflow passageway with a cross sectional area sufficient to provide a predetermined leakage airflow from an interior compartment of a motor vehicle.

In the following description, there are shown and described several preferred embodiments of the acoustic air duct, the air extraction system and the related method of reducing noise transmitted through an air duct. As it should be realized, the acoustic air duct, the air extraction system and the related method are capable of other, different embodiments and their several details are capable of modification in various, obvious aspects all without departing from the acoustic air duct, the air extraction system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the acoustic air duct, the air extraction system and the related method and together with the description serve to explain certain principles thereof.

FIG. 1 is a schematic illustration of the new and improved air extraction system incorporating the new and improved acoustic air duct.

FIG. 2a is a perspective view of a segment of one possible embodiment of that acoustic air duct.

FIG. 2b is a transverse cross sectional view of the segment of the acoustic air duct illustrated in FIG. 2a.

FIG. 2c is a cross sectional view of the acoustic air duct taken along line 2c-2c of FIG. 2b.

FIG. 3 is a cross sectional view of yet another embodiment of acoustic air duct.

Reference will now be made in detail to the present preferred embodiments of the acoustic air duct, air extraction system and related method of reducing noise transmitted through an air duct, examples of which are illustrated in the accompanying drawing figures.

### DETAILED DESCRIPTION

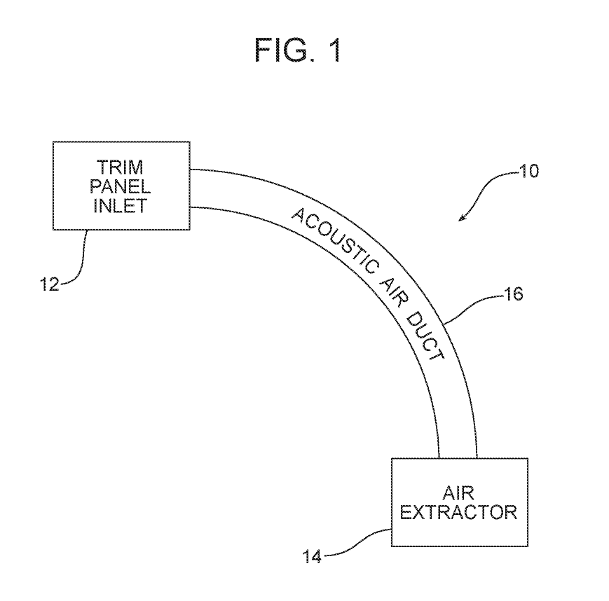

Reference is now made to FIG. 1 which schematically illustrates the new and improved air extraction system 10. That air extraction system 10 includes an air inlet, illustrated as a trim panel inlet 12. The trim panel inlet 12 is located in the passenger compartment of the motor vehicle such as, for example, in the package tray. The air extraction system 10 also includes an air extractor 14 which is typically provided in the sheet metal at the rear of the motor vehicle. In addition, the air extraction system 10 includes an acoustic air duct 16 that extends from the trim panel inlet 12 to the air extractor 14.

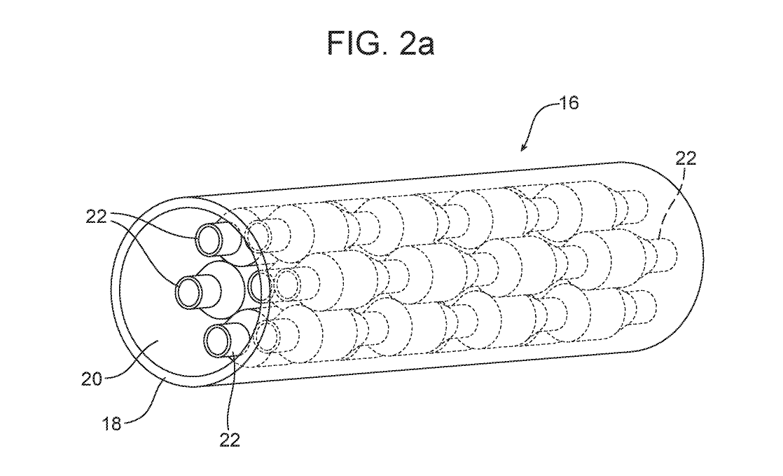

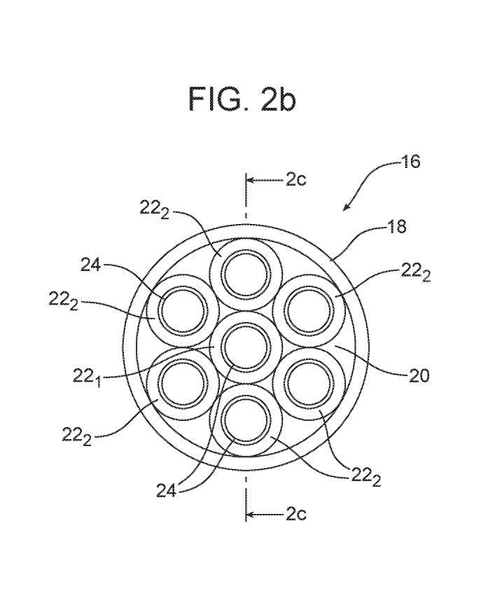

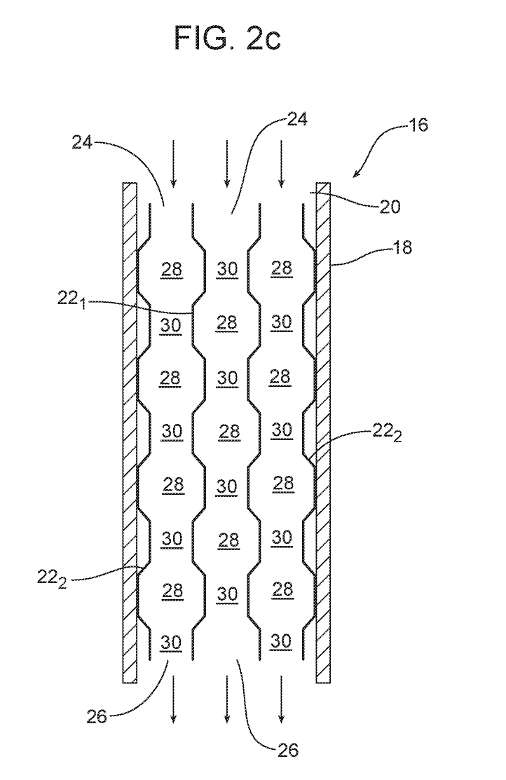

As illustrated in FIGS. 2a-2c, the acoustic air duct 16 includes an outer wall 18 defining an elongated airflow passageway 20. A plurality of channels 22 extend along the airflow passageway 20 within the outer wall 18. In the embodiment illustrated in FIGS. 2a-2c, at least one channel of the plurality of channels 22 has a circular cross section. In addition, each channel 22 includes an inlet end 24, an outlet end 26 and alternating expansion chambers 28 and constriction zones 30 provided in series therebetween.

In one of many possible embodiments, each expansion chamber 28 may have a first cross sectional area of between 320 mm² and 3200 mm² and each constriction zone 30 may have a second cross sectional area of between 80 mm² and 800 mm². Further each expansion chamber 28 may have a first total volume of between 8,182 mm³ and 487,680 mm³ while each constriction zone 30 may have a second total volume of between 2,032 mm³ and 121,920 mm³.

The plurality of channels 22 may be made from an acoustic material. Examples of acoustic materials that may be utilized to absorb or reduce sound include but are not necessarily limited to polyurethane, plastomer such as ethylene-alpha olefin copolymers and polyesters such as polyethylene terephthalate (PET). The outer wall 18 of the acoustic air duct 16 may also be made from an acoustic material if desired. The plurality of channels 22 may be made integral with the outer wall 18 such as by co-extrusion therewith or the plurality of channels may be provided by a separate partition body that is secured within the outer wall. Additive manufacturing may also be used.

In use, air traveling through the airflow passageway 20 of the acoustic air duct 16 from the trim panel inlet 12 to the air extractor 14 passes through the plurality of channels 22 by entering the various inlet ends 24. That air then passes serially through the alternating expansion chambers 28 and constriction zones 30 before exiting through the various outlet ends 26.

This air movement through the expansion chambers 28 and constriction zones 30 reduces NVH thereby reducing any transmission of noise through the air duct 16. Significantly, this is done without compromising airflow through the passenger compartment of the motor vehicle since the airflow passageway 20 provides a predetermined cross sectional area necessary to meet body leakage requirements for providing reduced door closing effort and optimal airflow in the passenger compartment so as to allow efficient and effective performance of the heating, ventilation and air conditioning (HVAC) system.

The resulting well ventilated, reduced noise environment enhances the satisfaction of the motor vehicle operator.

As illustrated in FIGS. 2b and 2c, it is possible to configure the plurality of channels 22 within the airflow passageway 20 to maximize airflow through the plurality of channels while still reducing noise transmission. As illustrated in FIG. 2b, the acoustic air duct 16 includes a first or center channel 221 and six second or outer channels 222 radially arrayed around the first channel. As best illustrated in FIG. 2c, the first channel 221 is oriented or configured with respect to the second channels 222 so that the expansion chambers 28 of the first channel 221 nest in the constriction zones 30 of the second channels 222 and the expansion chambers of the second channels 222 nest in the constriction zones of the first channel 221.

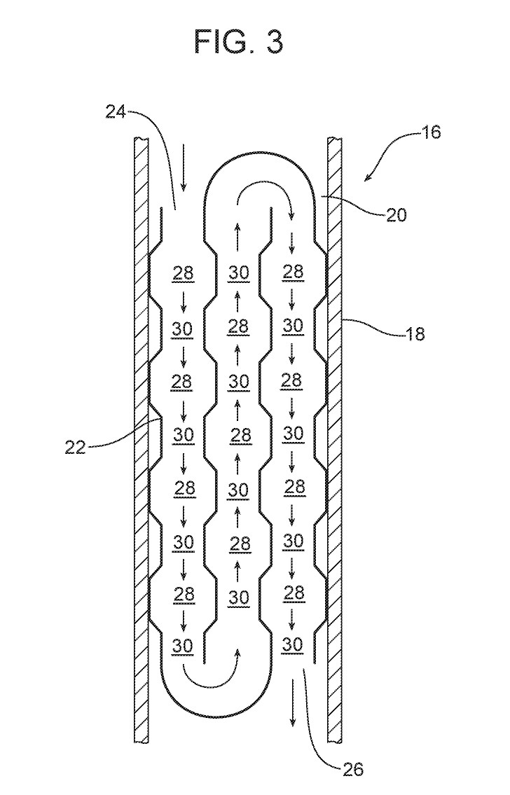

Reference is now made to FIG. 3 illustrating yet another embodiment of air duct 16 including an outer wall 18 defining an elongated air flow passageway 20 including a channel 22. The channel 22 includes an inlet end 24 and an outlet end 26. A series of expansion chambers 28 and construction zones 30 alternate along the length of the channel 22 which folds back upon itself twice.

Consistent with the above description, a method is provided for reducing noise transmitted through an air duct 16 such as illustrated in FIGS. 2a-2c. That method includes the step of dividing an internal airflow passageway 20 in the acoustic air duct 16 with a plurality of channels 22 wherein the first channel 221 of the plurality of channels includes alternating expansion chambers 28 and constriction zones 30.

The method may further include the step of internesting the first channel 221 with one or more second channels 222 also having alternating expansion chambers 28 and constriction zones 30. As a consequence, the expansion chambers 28 of the first channel 221 nest in the constriction zones 30 of the second channel(s) 222 and the expansion chambers of the second channel(s) nest in the constriction zones of the first channel.

Still further, the method may include making the plurality of channels 22 (including 221 and 222) from an acoustic material. Further, the method may include the step of extending the acoustic air duct 16 from an air inlet, such as a trim panel inlet 12 to an air extractor 14. Still further, the method may also include the step of providing the internal airflow passageway 20 with a cross sectional area sufficient to provide a predetermined leakage airflow from a passenger compartment of a motor vehicle.

In summary, the air extraction system 10 incorporates the air inlet/trim panel inlet 12, the air extractor 14 and an acoustic air duct 16 connecting and providing fluid communication between the air inlet/trim panel inlet 12 and the air extractor 14. Advantageously, the acoustic air duct 16 meets the seemingly conflicting requirements for optimizing airflow through the passenger compartment of a motor vehicle while also substantially reducing NVH. As such, the acoustic air duct 16 and air extraction system 10 both represent a significant advance in the art.

The foregoing has been presented for purposes of illustration and description. It is not intended to be exhaustive or to limit the embodiments to the precise form disclosed. Obvious modifications and variations are possible in light of the above teachings. For example, the channels 22 may extend through any portion or even all of the entire length of the elongated airflow passageway 20. Further, while the channels 22 of the illustrated embodiment are circular in cross section, it should be appreciated that they may assume substantially any other shape including, but not necessarily limited to elliptical, polygonal, as well as regular and irregular shapes. The channels 22 may also be all of the same cross sectional area or different cross sectional areas. All such modifications and variations are within the scope of the appended claims when interpreted in accordance with the breadth to which they are fairly, legally and equitably entitled.

What is claimed:

1. An acoustic air duct, comprising:
an outer wall defining an elongated internal airflow passageway; and
a plurality of channels extending along said elongated internal airflow passageway within said outer wall, a first channel of said plurality of channels including alternating expansion chambers and constriction zones.

2. The acoustic air duct of claim 1, wherein each expansion chamber of said expansion chambers has a first cross sectional area of between 320 mm² and 3,200 mm² and a first total volume of between 8,182 mm³ and 487,680 mm³.

3. The acoustic air duct of claim 2, wherein each constriction zone of said constriction zones has a second cross sectional area of between 80 mm² and 800 mm² and a second total volume of between 2,032 mm³ and 121,920 mm³.

4. The acoustic air duct of claim 3, wherein said plurality of channels are circular in cross section.

5. The acoustic air duct of claim 3, wherein said plurality of channels are made from an acoustic material.

6. The acoustic air duct of claim 1, wherein a second channel of said plurality of channels includes alternating expansion chambers and constriction zones.

7. The acoustic air duct of claim 6, wherein said expansion chambers of said first channel nest in said constriction zones of said second channel and said expansion chambers of said second channel nest in said constriction zones of said first channel.

8. An air extraction system for a motor vehicle, comprising:
a trim panel inlet;
an air extractor; and
an acoustic air duct including an outer wall defining an elongated internal passageway and a plurality of channels extending along said elongated internal passageway within said outer wall, a first channel of said plurality of channels including alternating expansion chambers and constriction zones.

9. The air extraction system of claim 8, wherein a second channel of said plurality of channels includes alternating expansion chambers and constriction zones.

10. The air extraction system of claim 9, wherein said expansion chambers of said first channel nest in said constriction zones of said second channel and said expansion chambers of said second channel nest in said constriction zones of said first channel.

11. The air extraction system of claim 10, wherein said plurality of channels are made from an acoustic material.

12. The air extraction system of claim 10, wherein said plurality of channels are circular in cross section.

13. A method of reducing noise transmitted through an air duct, comprising:
dividing an internal airflow passageway in said air duct with a plurality of channels wherein a first channel of said plurality of channels includes alternating expansion chambers and constriction zones.

14. The method of claim 13, including internesting said first channel with a second channel of said plurality of channels having alternating expansion chambers and constriction zones whereby said expansion chambers of said first channel nest in said constriction zones of said second channel and said expansion chambers of said second channel nest in said constriction zones of said first channel.

15. The method of claim 14, including making said plurality of channels from an acoustic material.

16. The method of claim 15, including extending said air duct from an air inlet to an air extractor.

17. The method of claim 16, including providing said internal airflow passageway with a cross sectional area to provide a predetermined leakage airflow from a passenger compartment of a motor vehicle.
